(19) United States
(12) Patent Application Publication
(10) Pub. No.: US 2025/0258450 A1
(43) Pub. Date: Aug. 14, 2025

(54) MAGNET ROLLER, MANUFACTURING METHOD FOR A MAGNET ROLLER, AND DEVELOPING APPARATUS

(71) Applicant: KYOCERA DOCUMENT SOLUTIONS INC., OSAKA (JP)

(72) Inventors: KAZUAKI EZURE, OSAKA (JP); YUKIMASA WATANABE, OSAKA (JP); HARUHIRO SATO, OSAKA (JP)

(21) Appl. No.: 19/054,163

(22) Filed: Feb. 14, 2025

(30) Foreign Application Priority Data
Feb. 14, 2024 (JP) 2024-020248

(51) Int. Cl. G03G 15/09

(52) U.S. Cl. CPC G03G 15/0921; G03G 2215/0861; G03G 2215/0863

(57) ABSTRACT

A magnet roller includes a shaft, a first magnet piece, and a second magnet piece. The first magnet piece and the second magnet piece are bonded to an outer circumference of the shaft with an adhesive. The first magnet piece has a first surface and a recessed portion. The recessed portion is recessed with respect to the first surface. The second magnet piece has a second surface and a convex portion. The second surface is held in contact with the first surface. The convex portion protrudes with respect to the second surface. The convex portion fits into the recessed portion.

### CROSS-REFERENCE TO RELATED PATENT APPLICATION

This application claims the benefit of Japanese Priority Patent Application JP 2024-020248 filed Feb. 14, 2024, under 35 U.S.C. 119, the entire contents of which are incorporated herein by reference.

### FIELD OF THE DISCLOSURE

The present disclosure relates to a magnet roller, a manufacturing method for a magnet roller, and a developing apparatus.

### BACKGROUND OF THE DISCLOSURE

A magnet roller according to Japanese Patent Application Laid-open No. 2008-158154 includes a magnet and a shaft. The magnet is constituted by five magnet pieces surrounding the shaft.

### SUMMARY OF THE DISCLOSURE

In accordance with a first aspect of the present disclosure, a magnet roller includes a shaft, a first magnet piece, and a second magnet piece. The first magnet piece and a second magnet piece are bonded to an outer circumference of the shaft with an adhesive. The first magnet piece has a first surface and a recessed portion. The recessed portion is recessed with respect to the first surface. The second magnet piece has a second surface and a convex portion. The second surface is held in contact with the first surface. The convex portion protrudes with respect to the second surface. The convex portion fits into the recessed portion.

In accordance with a second aspect of the present disclosure, a manufacturing method for a magnet roller is a manufacturing method for the magnet roller according to the first aspect of the present disclosure. The first magnet piece and the second magnet piece are mounted on a base. The second surface is brought into contact with the first surface so that the convex portion fits into the recessed portion. The first magnet piece and the second magnet piece with the convex portion fitting into the recessed portion is lifted from the base. The first magnet piece and the second magnet piece are bonded to the outer circumference of the shaft with the adhesive.

In accordance with a third aspect of the present disclosure, a developing apparatus with a magnet roller is a developing apparatus with the magnet roller according to the first aspect of the present disclosure. The developing apparatus includes a developing magnet roller. The developing magnet roller is arranged to face an image carrier that carries an electrostatic latent image. The developing magnet roller has a sleeve. The magnet roller is arranged inside the sleeve.

In accordance with the present disclosure, a technology that improves the accuracy of the magnetic properties and the shape can be provided.

These and other objects, features and advantages of the present disclosure will become more apparent in light of the following detailed description of best mode embodiments thereof, as illustrated in the accompanying drawings.

### BRIEF DESCRIPTION OF THE DRAWINGS

FIG. 1 is a perspective view of a magnet roller according to this embodiment.

FIG. 2 is a cross-sectional view of the magnet roller, which is taken along the line II-II in FIG. 1.

FIG. 3 is an enlarged cross-sectional view of a lower half of the magnet roller corresponding to FIG. 2, from which a second magnet piece is omitted.

FIG. 4 is an enlarged cross-sectional view of the lower half of the magnet roller corresponding to FIG. 2, from which a first magnet piece is omitted.

FIG. 5 is an enlarged cross-sectional view of the lower half of the magnet roller corresponding to FIG. 2.

FIG. 6A is a cross-sectional view showing the first magnet piece and the second magnet piece, which have been grounded on a base.

FIG. 6B is a cross-sectional view showing the first magnet piece and the second magnet piece with a second surface held in contact with a first surface at the base.

FIG. 6C is a cross-sectional view showing the first magnet piece and the second magnet piece, which have been lift from the base.

FIG. 6D is a cross-sectional view where the first magnet piece and the second magnet piece are to be bonded to an outer circumference of a shaft from below.

FIG. 7 is a cross-sectional view where the first magnet piece and the second magnet piece are to be bonded to the outer circumference of the shaft from above.

FIG. 8 is a perspective view of a developing apparatus and an image carrier.

FIG. 9 is a schematic view of an image forming apparatus.

FIG. 10 is a schematic enlarged view of an image forming part.

### DETAILED DESCRIPTION OF THE EXEMPLARY EMBODIMENTS

Hereinafter, an embodiment of the present disclosure will be described with reference to the drawings. Note that in the figures, the same or corresponding portions will be denoted by the same reference signs and the descriptions will not be repeated. Moreover, in the following description, even when terms meaning specific positions and directions are used, these terms are used for the sake of convenience to make the contents of the embodiment easily understood, and they are not related to directions when it is actually carried out.

### EMBODIMENT

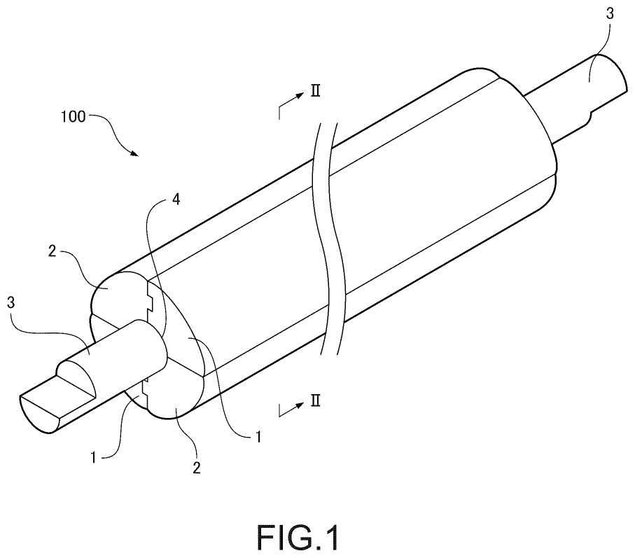

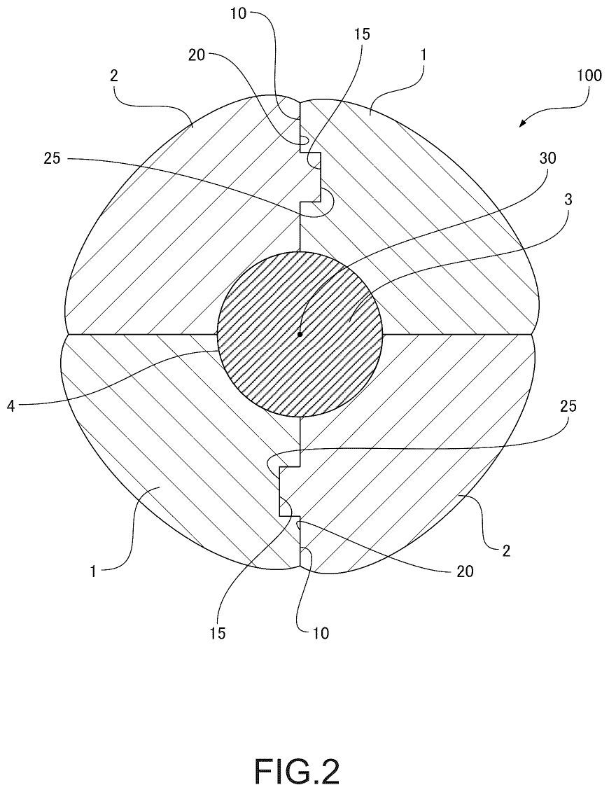

A magnet roller 100 according to this embodiment will be described with reference to FIGS. 1 and 2. FIG. 1 is a perspective view of the magnet roller 100 according to this embodiment. FIG. 2 is a cross-sectional view of the magnet roller 100, which is taken along the line II-II in FIG. 1.

As shown in FIG. 1, the magnet roller 100 includes a shaft 3, a first magnet piece 1, and a second magnet piece 2. The first magnet piece 1 and the second magnet piece 2 are bonded to an outer circumference of the shaft 3 with an adhesive 4.

As shown in FIG. 2, the first magnet piece 1 has a first surface 10 and a recessed portion 15. The recessed portion 15 is recessed with respect to the first surface 10. The second magnet piece 2 has a second surface 20 and a convex portion 25. The second surface 20 is held in contact with the first surface 10. The convex portion 25 protrudes with respect to the second surface 20. The convex portion 25 fits into the recessed portion 15.

Such a configuration can improve the accuracy of the magnetic properties and the shape. Specifically, fitting the convex portion 25 into the recessed portion 15 omits an adhesive for bonding the first magnet piece 1 and the second magnet piece 2 or reduces the required amount of adhesive. Therefore, there is no adhesive between the first magnet piece 1 and the second magnet piece 2 and the shaft 3, and they can be arranged close together. Moreover, fitting the convex portion 25 into the recessed portion 15 suppresses the misalignment between the first magnet piece 1 and the second magnet piece 2. Therefore, the magnet roller 100 can improve the accuracy of the magnetic properties and the shape by appropriately arranging the first magnet piece 1, the second magnet piece 2, and the shaft 3.

Here, magnet pieces adjacent to each other in a conventional magnet roller described in Japanese Patent Application Laid-open No. 2008-158154 have to be bonded at their flat contact surfaces with an adhesive. On the other hand, when the contact surfaces are bonded with an adhesive, the adhesive leaks out from the ends of the contact surfaces to an inner peripheral side of the magnet pieces in some cases. In these cases, the adhesive is cured between the magnet pieces and the shaft on the inner peripheral side of the magnet pieces. It is thus difficult to arrange the magnet pieces and the shaft close together. Therefore, the conventional magnet roller cannot improve the accuracy of the magnetic properties and the shape because it is difficult to suitably arrange them. In contrast, the above-mentioned magnet roller 100 can improve the accuracy of the magnetic properties and the shape.

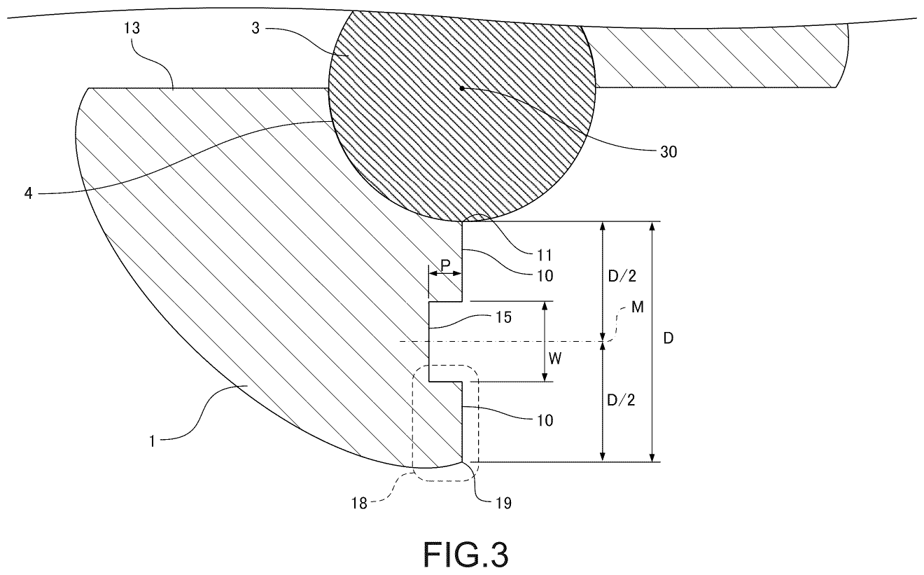

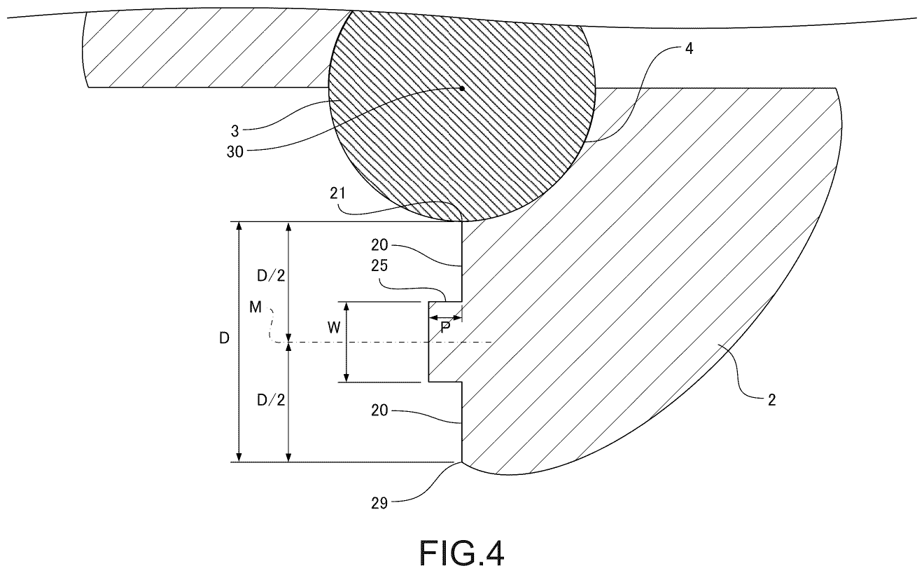

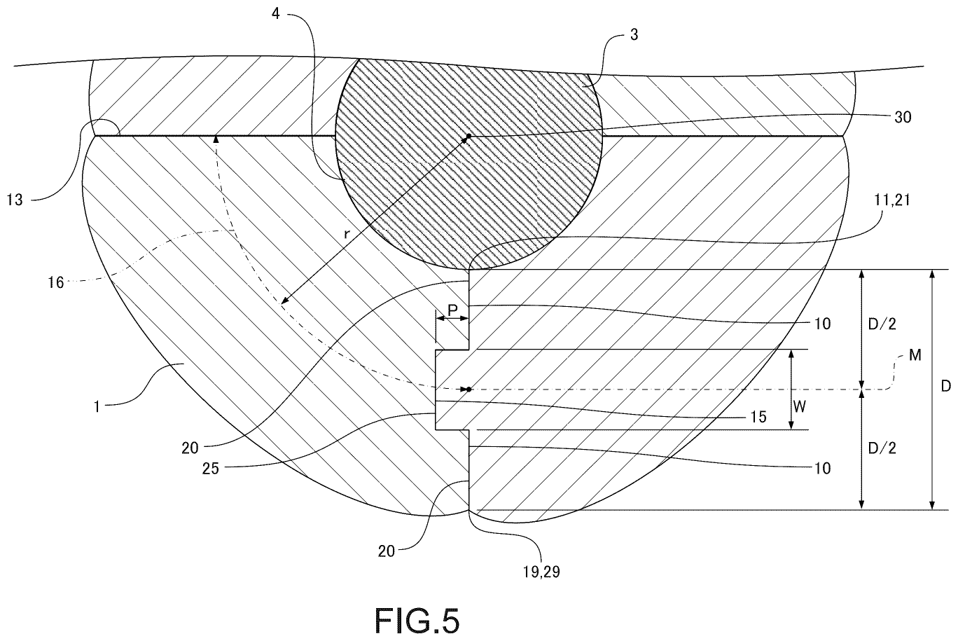

Hereinafter, the magnet roller 100 will be described in detail with reference to FIGS. 3 to 5. FIG. 3 is an enlarged cross-sectional view of a lower half of the magnet roller 100 corresponding to FIG. 2, from which the second magnet piece 2 is omitted. FIG. 4 is an enlarged cross-sectional view of the lower half of the magnet roller 100 corresponding to FIG. 2 in which the first magnet piece 1 is omitted. FIG. 5 is an enlarged cross-sectional view of the lower half of the magnet roller 100 corresponding to FIG. 2.

As shown in FIGS. 3 and 4, the recessed portion 15 and the convex portion 25 each have a width W in a radial direction of the shaft 3. The width W of each of the recessed portion 15 and the convex portion 25 is 40% or less of a distance between the one end 11, 21 and the other end 19, 29 in the radial direction of each of the first surface 10 and the second surface 20 and is 0.5 mm or more. Note that the distance between the one end 11, 21 and the other end 19, 29 in the radial direction of each of the first surface 10 and the second surface 20 will be also referred to as a contact surface distance D.

When the width W of each of the recessed portion 15 and the convex portion 25 is 40% or more of the contact surface distance D, as shown in FIG. 3, a recessed-portion outer portion 18, which ranges from the other end 19 in the radial direction of the first surface 10 to the recessed portion 15, has a shape difficult to deform. Therefore, the recessed-portion outer portion 18 is not easily deformed even when the convex portion 25 fits into the recessed portion 15, and adverse effects on the magnetic properties are suppressed. Thus, the magnet roller 100 can further improve the accuracy of the magnetic properties by suppressing the adverse effects on the magnetic properties.

Setting the width W of each of the recessed portion 15 and the convex portion 25 to 0.5 mm or more further suppress the misalignment between the first magnet piece 1 and the second magnet piece 2. Thus, the magnet roller 100 can further improve the accuracy of the shape by further suppressing the misalignment between the first magnet piece 1 and the second magnet piece 2.

The width W of each of the recessed portion 15 and the convex portion 25 is favorably 1.0 mm or more. That is because setting the width W of each of the recessed portion 15 and the convex portion 25 to 1.0 mm or more further suppresses the misalignment between the first magnet piece 1 and the second magnet piece 2.

As shown in FIG. 5, the recessed portion 15 and the convex portion 25 each have a depth and a length P in directions orthogonal to the radial direction of the shaft 3. The first magnet piece 1 has a third surface 13 in addition to the first surface 10 and the recessed portion 15.

Here, a midpoint that is located at an equal distance from the one end 11, 21 and the other end 19, 29 in the radial direction of each of the first surface 10 and the second surface 20 will be also referred to as a contact surface midpoint M. Moreover, in a case where a circular arc 16 with a center at an axial center 30 of the shaft 3 has both ends at the contact surface midpoint M and at the third surface 13, the length of the circular arc 16 will be also referred to as a predetermined circular arc length. Note that a radius r of the circular arc 16 corresponds to a distance between the axial center 30 of the shaft 3 and the contact surface midpoint M.

The depth and the length P of each of the recessed portion 15 and the convex portion 25 are 23% or less and 1.0 mm or more of the predetermined circular arc length.

Setting the depth and the length P of each of the recessed portion 15 and the convex portion 25 to 23% or less of the predetermined circular arc length reduces a part of the second magnet piece 2, which enters the first magnet piece 1 as the convex portion 25. Thus, the magnetic force of the second magnet piece 2 does not significantly interfere with the magnetic force of the first magnet piece 1, so adverse effects on the magnetic properties are suppressed. Thus, the magnet roller 100 can further improve the accuracy of the magnetic properties.

Setting the depth and the length P of each of the recessed portion 15 and the convex portion 25 to 1.0 mm or more further suppresses the misalignment between the first magnet piece 1 and the second magnet piece 2. Thus, the magnet roller 100 can further improve the accuracy of the shape.

As shown in FIGS. 3 to 5, the recessed portion 15 and the convex portion 25 are each symmetric with respect to the contact surface midpoint M, which is a midpoint of the one end 11, 21 and the other end 19, 29 in the radial direction of each of the first surface 10 and the second surface 20, on a side closer to the shaft 3 and a side further from the shaft 3.

Configuring each of the recessed portion 15 and the convex portion 25 to be symmetric with respect to the contact surface midpoint M on the side closer to the shaft 3 and the side further from the shaft 3 suppresses adverse effects on the magnetic properties. Thus, the magnet roller 100 can further improve the accuracy of the magnetic properties by suppressing adverse effects on the magnetic properties.

The term “symmetric” can have both meanings “partially symmetric” and “perfectly symmetric.” As shown in FIGS. 3 to 5, it is favorable that each of the recessed portion 15 and the convex portion 25 are perfectly symmetric with respect to the contact surface midpoint M on the side closer to the shaft 3 and the side further from the shaft 3. Configuring it to be perfectly symmetric further suppresses adverse effects on the magnetic properties.

Hereinafter, the material of the first magnet piece 1 and the second magnet piece 2 will be described in detail.

The first magnet piece 1 and the second magnet piece 2 are made of magnetic powder and resin. The magnetic powder includes ferrite. The ferrite is, for example, anisotropic ferrite. The configuration in which the magnetic powder includes ferrite improves the magnetic properties. Thus, the magnet roller 100 can further improve the accuracy of the magnetic properties.

The magnetic powder further includes rare-earth magnetic powder other than the ferrite. The rare-earth magnetic powder is, for example, neodymium, samarium-cobalt, or samarium-iron-nitrogen. Since the magnetic powder is a mixture (blend) of ferrite and rare-earth magnetic powder, the magnetic properties are improved. Thus, the magnet roller 100 can further improve the accuracy of the magnetic properties.

### EXAMPLES

Next, the magnet roller 100 according to the present disclosure will be specifically described on the basis of examples, though the present disclosure is not limited to the following examples.

In all the examples, the size and the material of the magnet roller 100 were set to be the same and only conditions (width W, depth, and length P) of the recessed portion 15 and the convex portion 25 were set to be different. Specifically, in the first magnet piece 1 and the second magnet piece 2 shown in FIG. 5, the length between the both ends in the width W direction of each of the recessed portion 15 and the convex portion 25 (between the top and bottom) was set to 5 mm and the depth and the length between the both ends in the length P direction of each of the recessed portion 15 and the convex portion 25 (between left and right) was set to 8 mm. Moreover, the first magnet piece 1 and the second magnet piece 2 were made of resin containing polychloroethylene as a main component and magnetic powder of anisotropic ferrite (85% by weight). The shaft 3 was φ6-330 mm, made of SUM23 with nickel plating of 5 μm±2 μm. The adhesive 4 was Aron Alpha (registered trademark) 800 series.

In all the examples, an automatic magnetic field distribution measurement apparatus 6800ROLL2 manufactured by Nihon Denji Sokki co., ltd was used for measuring the magnetic properties. The measurement positions were set to 10 positions evenly along the direction of the axial center 30 of the shaft 3, spaced away from the axial center 30 of the shaft 3 by 10 mm. The rotational speed of the shaft 3 was set to about 6 seconds/rotation.

Of all the examples (Examples 1 to 15), Examples 1 to 7 are shown in the following Table 1 and Examples 8 to 15 are shown in the following Table 2. Table 1 shows a summary of Examples 1 to 7 that obtained more favorable results. Table 2 shows a summary of Examples 8 to 15 that obtained more favorable results, which are not as favorable as those in Table 1.

In Table 1 and Table 2 below, the “width W of each of the recessed portion 15 and the convex portion 25 with respect to the contact surface distance D” will be simply referred to as a “relative width,” the “depth and the length P of each of the recessed portion 15 and the convex portion 25 with respect to the predetermined circular arc length” will be simply referred to as a “relative depth, etc.,” and the “misalignment between the first magnet piece 1 and the second magnet piece 2” will be simply referred to as “misalignment between magnets.”

TABLE 1

| | Conditions | | Magnetic properties | | | Misalignment |
|---|---|---|---|---|---|---|
| | Relative | Relative | Magnetic | Polar | Half | between |
| | width | depth, etc. | force *1 | angle *2 | width *3 | magnets |
| Example 1 | 40% | 23% | 55.5 mT | 0.5° | 50.3° | None |
| Example 2 | 30% | 23% | 55.2 mT | 0.2° | 49.8° | None |
| Example 3 | 20% | 23% | 55.0 mT | 0.1° | 50.3° | None |
| Example 4 | 10% | 23% | 55.6 mT | 0.3° | 50.2° | None |
| Example 5 | 40% | 15% | 55.5 mT | 0.2° | 50.5° | None |
| Example 6 | 40% | 12.5% | 55.1 mT | 0.3° | 49.9° | None |
| Example 7 | 10% | 12.5% | 55.3 mT | 0.5° | 50.2° | None |

TABLE 2

| | Conditions | | Magnetic properties | | | Misalignment |
|---|---|---|---|---|---|---|
| | Relative | Relative | Magnetic | Polar | Half | between |
| | width | depth, etc. | force *1 | angle *2 | width *3 | magnets |
| Example 8 | 45% | 23% | 54.3 mT | −3.8° | 50.1° | None |
| Example 9 | 50% | 23% | 54.2 mT | −5.8° | 49.7° | None |
| Example 10 | 60% | 23% | 53.9 mT | −7.6° | 49.5° | None |
| Example 11 | 8% | 23% | 55.5 mT | 0.5° | 50.1° | Low |
| | (0.4 mm) | | | | | |
| Example 12 | 40% | 25% | 53.5 mT | 1.7° | 46.6° | None |
| Example 13 | 40% | 30% | 51.1 mT | 2.6° | 46.1° | None |
| Example 14 | 40% | 40% | 49.3 mT | 4.2° | 45.5° | None |
| Example 15 | 40% | 10% | 54.6 mT | 0.1° | 50.7° | Low |
| | | (0.8 mm) | | | | |

*1: The magnetic force is 55 ± 6 mT as a favorable range and is 55 ± 5 mT as a more favorable range.
*2: The polar angle is 0 ± 8 as a favorable range and is 0 ± 3 as a more favorable range.
*3: The half width is 50 ± 5 as a favorable range and is 50 ± 3 as a more favorable range.

As shown in Table 1, under the conditions satisfying (1) and (2) below, more favorable results were obtained in terms of the magnetic properties and the misalignment between the magnets.

(1) The relative width is 40% or less and 10% (0.5 mm) or more.
(2) The relative depth, etc. is 23% or less and 12.5% (1.0 mm) or more.

As shown in Table 2, under the conditions satisfying (3) and (4) below, favorable results, which are not as favorable as those in Table 1, were obtained in terms of the magnetic properties and the misalignment between the magnets.

(3) The relative width is 60% or less and 8% (0.4 mm) or more.
(4) The relative depth, etc. is 40% or less and 10% (0.8 mm) or more.

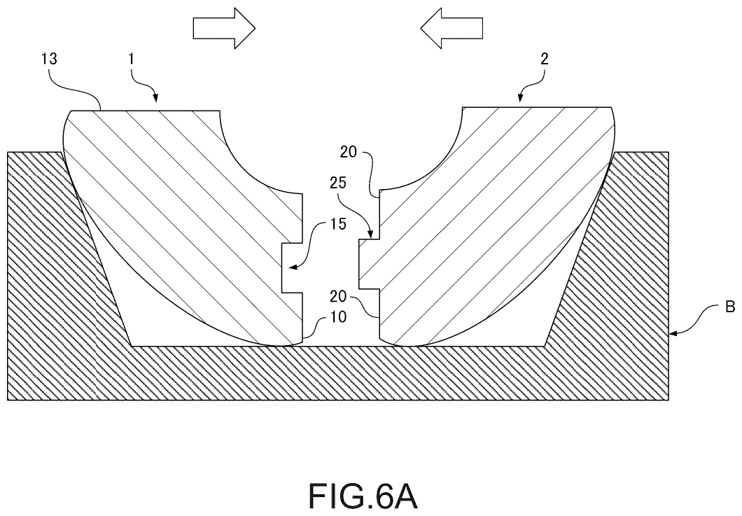

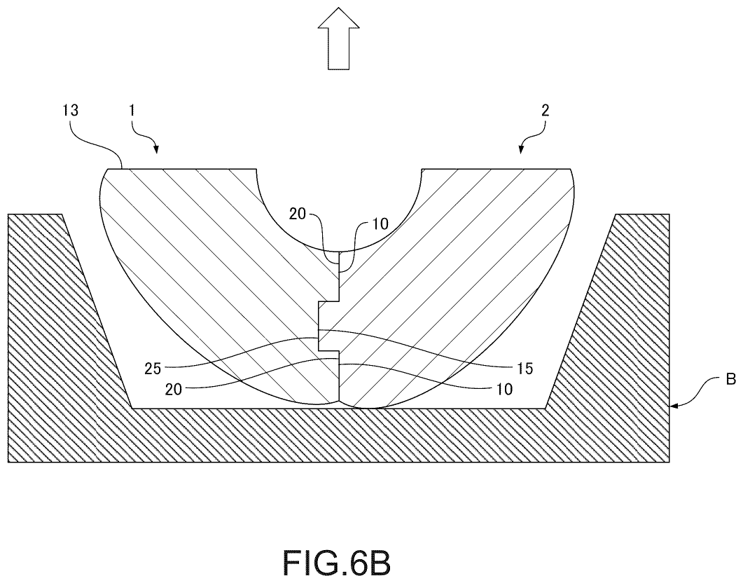

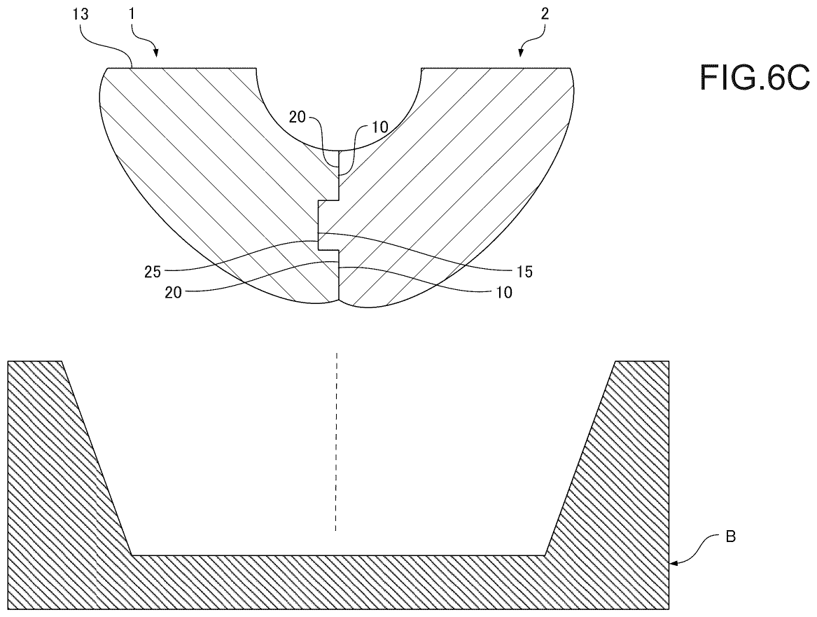

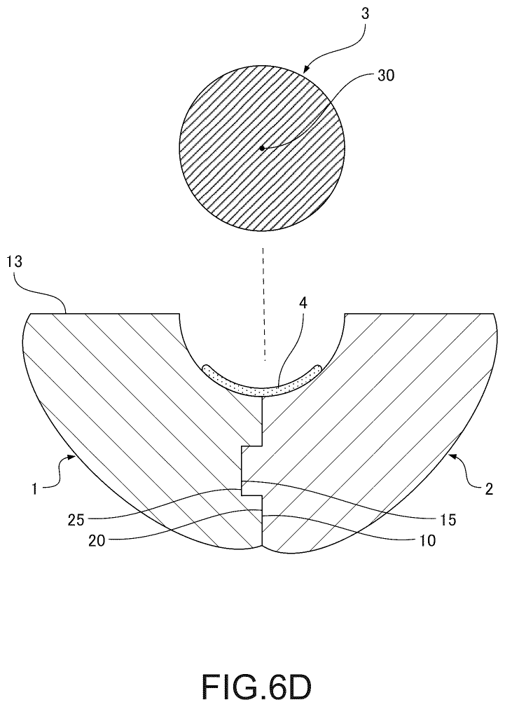

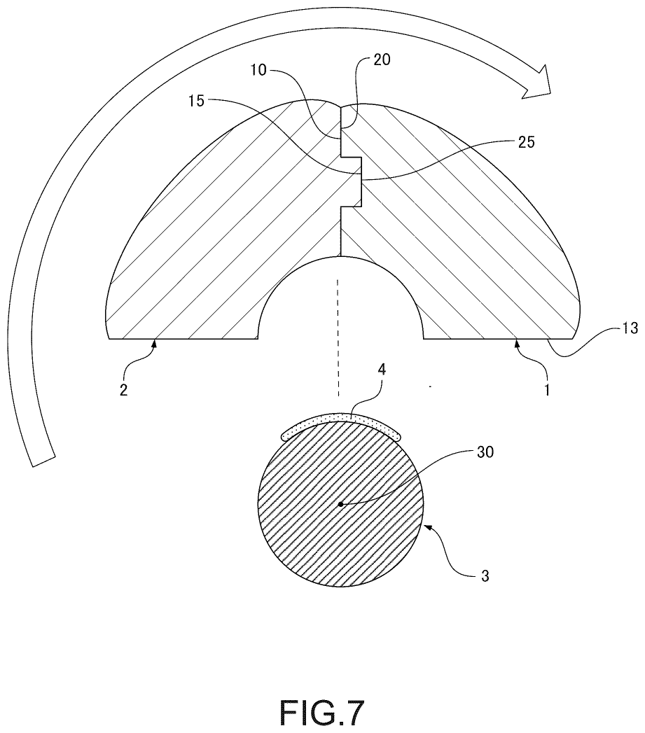

Hereinafter, a manufacturing method for the magnet roller 100 will be described with reference to FIGS. 6A to 6D and FIG. 7. FIG. 6A is a cross-sectional view showing the first magnet piece 1 and the second magnet piece 2, which have been grounded on a base B. FIG. 6B is a cross-sectional view showing the first magnet piece 1 and the second magnet piece 2 with the first surface 10 held in contact with the second surface 20 on the base B. FIG. 6C is a cross-sectional view showing the first magnet piece 1 and the second magnet piece 2, which have been lifted from the base B. FIG. 6D is a cross-sectional view where the first magnet piece 1 and the second magnet piece 2 are to be bonded to the outer circumference of the shaft 3 from below. FIG. 7 is a cross-sectional view where the first magnet piece 1 and the second magnet piece 2 are to be bonded to the outer circumference of the shaft 3 from above.

As shown in FIG. 6A, a worker or an apparatus for the work (both are not shown) places the first magnet piece 1 and the second magnet piece 2 on the base B.

As shown in FIG. 6B, the worker or the apparatus for the work (both are not shown) brings the second surface 20 into contact with the first surface 10 so that the convex portion 25 fits into the recessed portion 15.

As shown in FIG. 6C, the worker or the apparatus for the work (both are not shown) lifts from the base B the first magnet piece 1 and the second magnet piece 2 with the convex portion 25 fitting into the recessed portion 15.

As shown in FIG. 6D, the worker or the apparatus for the work (both are not shown) bonds the first magnet piece 1 and the second magnet piece 2 to the shaft 3 from the outer circumference with the adhesive 4.

Since the convex portion 25 fits into the recessed portion 15 in the first magnet piece 1 and the second magnet piece 2, the misalignment is suppressed when lifting and attaching to the shaft 3. Therefore, in the manufacturing method for the magnet roller 100, the magnet roller 100 with the improved accuracy of the magnetic properties and the shape can be manufactured.

The first magnet piece 1 and the second magnet piece 2 may be bonded to the shaft 3 from below as shown in FIG. 6D or the first magnet piece 1 and the second magnet piece 2 may be bonded to the shaft 3 from above as shown in FIG. 7. The first magnet piece 1 and the second magnet piece 2 have to be inverted vertically from the lifted state in order to bond them to the shaft 3 from above.

Since the convex portion 25 fits into the recessed portion 15 in the first magnet piece 1 and the second magnet piece 2, the misalignment is suppressed during the vertical inversion. Therefore, in the manufacturing method for the magnet roller 100, the magnet roller 100 with the improved accuracy of the shape can be manufactured.

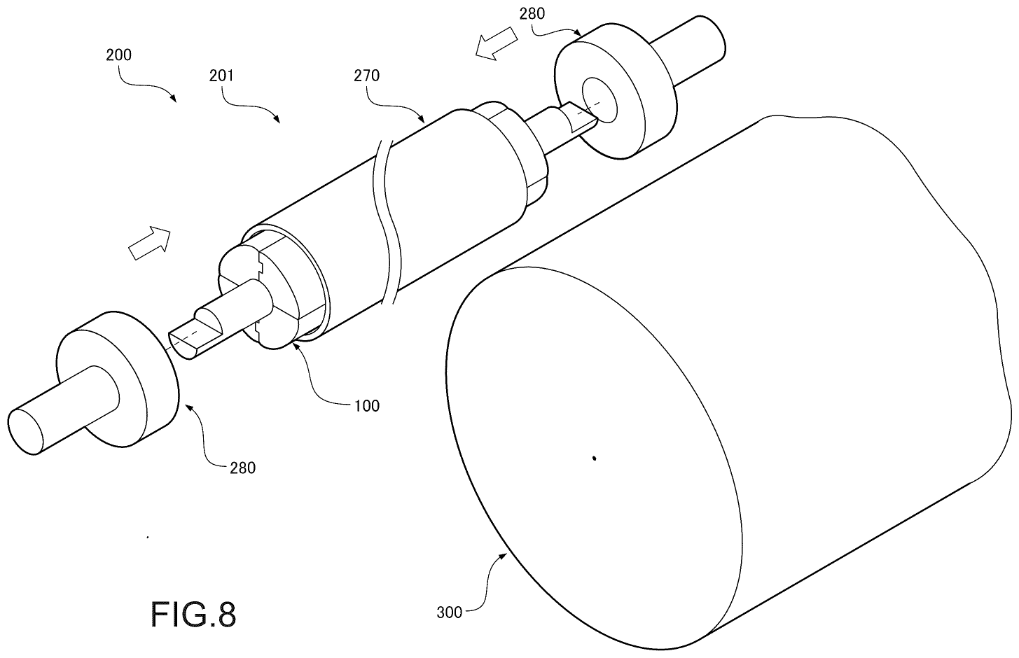

Hereinafter, a developing apparatus 200 with the magnet roller 100 will be described with reference to FIG. 8. FIG. 8 is a perspective view of the developing apparatus 200 and an image carrier 300.

The developing apparatus 200 includes a developing magnet roller 201. The developing magnet roller 201 is arranged to face the image carrier 300. The image carrier 300 carries an electrostatic latent image.

The developing magnet roller 201 includes the magnet roller 100 and a sleeve 270. The magnet roller 100 is arranged inside the sleeve 270.

The developing apparatus 200 develops the electrostatic latent image on the image carrier 300 as a toner image with high accuracy. In particular, the developing apparatus 200 can develop the electrostatic latent image with high accuracy due to the magnet roller 100 with the improved accuracy of the magnetic properties and the shape.

The developing magnet roller 201 further includes two flanges 280. The two flanges 280 are adhered to the sleeve 270 to close two openings of the sleeve 270. The sleeve 270 and the flanges 280 are both made of aluminum.

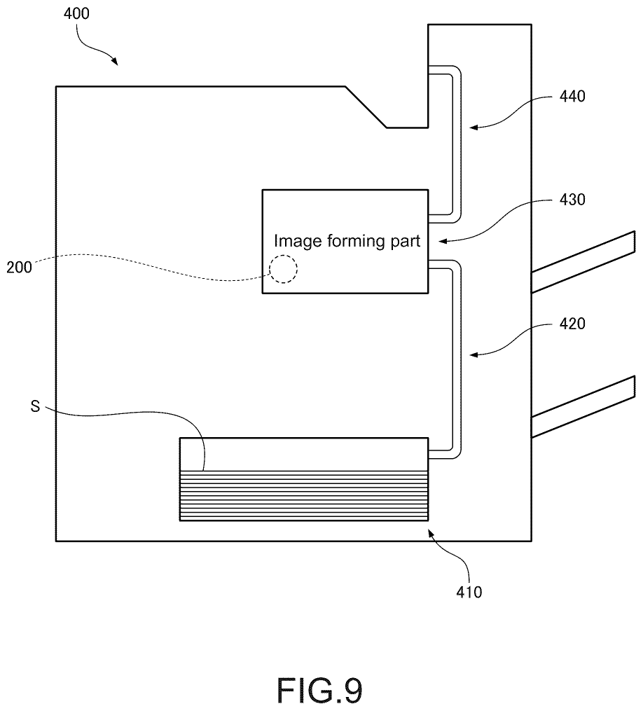

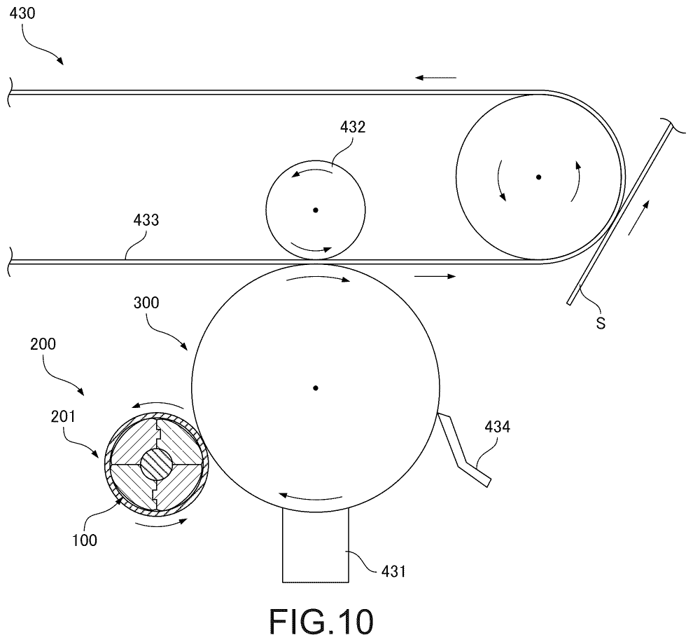

Hereinafter, an image forming apparatus 400 with the developing apparatus 200 will be described with reference to FIGS. 9 and 10. FIG. 9 is a schematic view of the image forming apparatus 400. FIG. 10 is a schematic enlarged view of an image forming part 430.

As shown in FIG. 9, the image forming apparatus 400 includes a sheet storage part 410, an upstream-side sheet conveyance path 420, the image forming part 430, and a downstream-side sheet conveyance path 440.

The sheet storage part 410 stores sheets S. The upstream-side sheet conveyance path 420 conveys the sheets S to the image forming part 430 from the sheet storage part 410. The image forming part 430 forms images on the sheets S. The downstream-side sheet conveyance path 440 conveys the sheets S from the image forming part 430. Multiple conveyance rollers (not shown) that convey the sheets S are arranged on the upstream-side sheet conveyance path 420 and the downstream-side sheet conveyance path 440.

As shown in FIG. 10, the image forming part 430 includes the image carrier 300, a charging apparatus 431, the developing apparatus 200, a transferring roller 432, a transferring belt 433, and a cleaning member 434.

The image carrier 300 is a member having a photosensitive layer on its surface (circumferential surface). The image carrier 300 is driven by, for example, a motor (not shown). The image carrier 300 is, for example, a photosensitive drum.

The charging apparatus 431 uniformly charges the surface of the image carrier 300. An electrostatic latent image is formed by an exposure apparatus (not shown) on the uniformly charged surface of the image carrier 300.

The developing apparatus 200 develops the electrostatic latent image on the image carrier 300 as a toner image by using a two-component developer including toner and carrier.

The transferring roller 432 faces the image carrier 300 with the transferring belt 433 therebetween. The transferring roller 432 transfers the toner image formed on the surface of the image carrier 300 to the transferring belt 433.

The transferring belt 433 transfers the transferred toner image to one of the sheets S. The transferring belt 433 is, for example, an endless belt.

The cleaning member 434 removes the toner remaining on the surface of the image carrier 300. The surface of the image carrier 300 from which the toner has been removed can be uniformly charged again.

Hereinabove, the embodiment of the present disclosure has been described with reference to the drawings. Note that the present disclosure is not limited to the above-mentioned embodiment, and may be carried out in various aspects without departing from the gist. For easy understanding, the drawings each schematically show configurations of elements mainly, and the thickness, the length, the number of items, the intervals, and the like of each component shown in the figure are different from the actual ones for the sake of convenience for creating the drawings. Moreover, the speed, the material, the shape, the dimensions, and the like of each component shown in the above-mentioned embodiment, and there are no particular limitations and various modifications can be made without substantially departing from the configurations of the present disclosure.

Although the first magnet piece 1 and the second magnet piece 2 are made of the resin and magnetic powder in the above-mentioned embodiment, the first magnet piece 1 and the second magnet piece 2 may be made of rubber.

Although the shaft 3 is shown as a cylindrical shape in the embodiment, another shape, such as a prism shape, may be employed.

Although the first magnet piece 1 and the second magnet piece 2 are shown as fan-shapes in the transverse section in the embodiment, other shapes may be employed.

It should be understood by those skilled in the art that various modifications, combinations, sub-combinations and alterations may occur depending on design requirements and other factors insofar as they are within the scope of the appended claims or the equivalents thereof.

What is claimed is:

1. A magnet roller, comprising:
a shaft; and
a first magnet piece and a second magnet piece that are bonded to an outer circumference of the shaft with an adhesive, wherein
the first magnet piece has
a first surface, and
a recessed portion that is recessed with respect to the first surface, and
the second magnet piece has
a second surface that is held in contact with the first surface, and
a convex portion that protrudes with respect to the second surface and fits into the recessed portion.

2. The magnet roller according to claim 1, wherein
the recessed portion and the convex portion each have a width in a radial direction of the shaft, and
the width is 40% or less of a distance between one end and another end in the radial direction of each of the first surface and the second surface and is 0.5 mm or more.

3. The magnet roller according to claim 1, wherein
the recessed portion and the convex portion each have a depth and a length in directions orthogonal to the radial direction of the shaft,
the first magnet piece further has a third surface in addition to the first surface and the recessed portion,
in a case where a circular arc with a center at an axial center of the shaft has both ends at a midpoint from the one end to the other end in the radial direction of the first surface and at the third surface, a length of the circular arc is defined as a predetermined circular arc length, and
each of the depth and the length is 23% or less of the predetermined circular arc length and is 1.0 mm or more.

4. The magnet roller according to claim 2, wherein
the recessed portion and the convex portion are respectively symmetric on a side closer to the shaft and a side further to the shaft with respect to the midpoint of the one end and the other end in the radial direction of the first surface and the second surface.

5. The magnet roller according to claim 4, wherein
the first magnet piece and the second magnet piece include magnetic powder and resin, and
the magnetic powder includes ferrite.

6. The magnet roller according to claim 5, wherein
the magnetic powder further includes rare-earth magnetic powder.

7. A manufacturing method for the magnet roller according to claim 1, comprising:
mounting the first magnet piece and the second magnet piece on a base;
bringing the second surface into contact with the first surface so that the convex portion fits into the recessed portion;
lifting the first magnet piece and the second magnet piece with the convex portion fitting into the recessed portion from the base; and
bonding the first magnet piece and the second magnet piece to the outer circumference of the shaft with the adhesive.

8. A developing apparatus with the magnet roller according to claim 1, comprising:
a developing magnet roller arranged to face an image carrier that carries an electrostatic latent image, wherein
the developing magnet roller has a sleeve inside which the magnet roller is arranged.
